(19) United States
(12) Patent Application Publication
(10) Pub. No.: US 2015/0183310 A1
(43) Pub. Date: Jul. 2, 2015

(54) TOP COVER FOR CONVERTIBLE CARS

(71) Applicant: Dwight Cook, Sylacauga, AL (US)

(72) Inventor: Dwight Cook, Sylacauga, AL (US)

(21) Appl. No.: 14/509,739

(22) Filed: Oct. 8, 2014

Related U.S. Application Data
(60) Provisional application No. 61/863,784, filed on Aug. 8, 2013.

(51) Int. Cl. B60J 11/06

(52) U.S. Cl. CPC B60J 11/06

(57) ABSTRACT

A top cover that covers a convertible top of a convertible car is provided. The top cover includes a body having a front portion, a middle portion, and a rear portion. An edge is formed around the perimeter of the body. The body is made of a flexible material shaped to cover the convertible top of the car. The flexible material may include, but is not limited to, vinyl, canvas, leather or other textile material. A connector is used to releasably attach the edge of the body to the convertible top of the car, thereby covering the convertible top.

### CROSS-REFERENCE TO RELATED APPLICATION

This application claims the benefit of priority of U.S. provisional application number 61/863,784, filed Aug. 8, 2013, the contents of which are herein incorporated by reference.

### BACKGROUND OF THE INVENTION

The present invention relates to convertible tops and, more particularly, to a top cover for convertible cars.

A convertible is a type of automobile that can convert from open-aft (top-down or topless) mode to a provisionally enclosed (roofed or top-up) mode. Contemporary roofs are often hinged to fold away, either into a recess behind the rear seats or into the boot or trunk of the vehicle. The roof may operate either manually or automatically via hydraulic or electrical actuators, and the roof itself may be constructed of soft or rigid material. Soft-tops are made of vinyl, canvas or other textile material. Typically the soft-top material wears over time and becomes aesthetically displeasing. Currently, the only remedy is completely replacing the soft-top, which is expensive.

As can be seen, there is a need for an inexpensive device for protecting and covering the existing soft-top material of a convertible.

### SUMMARY OF THE INVENTION

In one aspect of the present invention, a convertible car top cover comprises: a body comprising a front portion, a rear portion, and a middle portion forming an edge around the perimeter of the body, wherein the body comprises a flexible material shaped to cover a convertible top of a car; and a connector releasably attaching the edge of the body to the convertible top of the car.

In another aspect of the present invention, a method of attaching a cover to a convertible car comprises: providing a convertible car top cover comprising a front portion, a rear portion, and a middle portion forming an edge around the perimeter of the body, wherein the edge comprises a first mating connector; affixing a second mating connector to a convertible top of the car, wherein the second mating connector mates with and releasably attaches with the first mating connector; and attaching the first mating connector with the second mating connector, thereby attaching the convertible car top cover over the convertible top of the car.

These and other features, aspects and advantages of the present invention will become better understood with reference to the following drawings, description and claims.

### BRIEF DESCRIPTION OF THE DRAWINGS

FIG. 1 is an exploded view of an embodiment of the present invention shown in use;

FIG. 2 is a perspective view of an embodiment of the present invention shown in use;

FIG. 3 is a bottom view of an embodiment of the present invention;

FIG. 4 is a bottom view of an embodiment of the present invention;

FIG. 5 is a bottom view of an embodiment of the present invention;

FIG. 6 is a bottom view of an embodiment of the present invention;

FIG. 7 is a bottom view of an embodiment of the present invention;

FIG. 8 is a bottom view of an embodiment of the present invention; and

FIG. 9 is a bottom view of an embodiment of the present invention without tubing.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a top cover for a convertible top of a car. The top cover may be sewn fabric that protects the convertible top as well as adding aesthetic value to the car. The top cover may cover old, torn, faded, scratched, ripped and unpleasant soft-top convertible tops. The top cover may further be customized to include logos, team names, designs, colors, and the like. The present invention is easy to install and does not require professional installation.

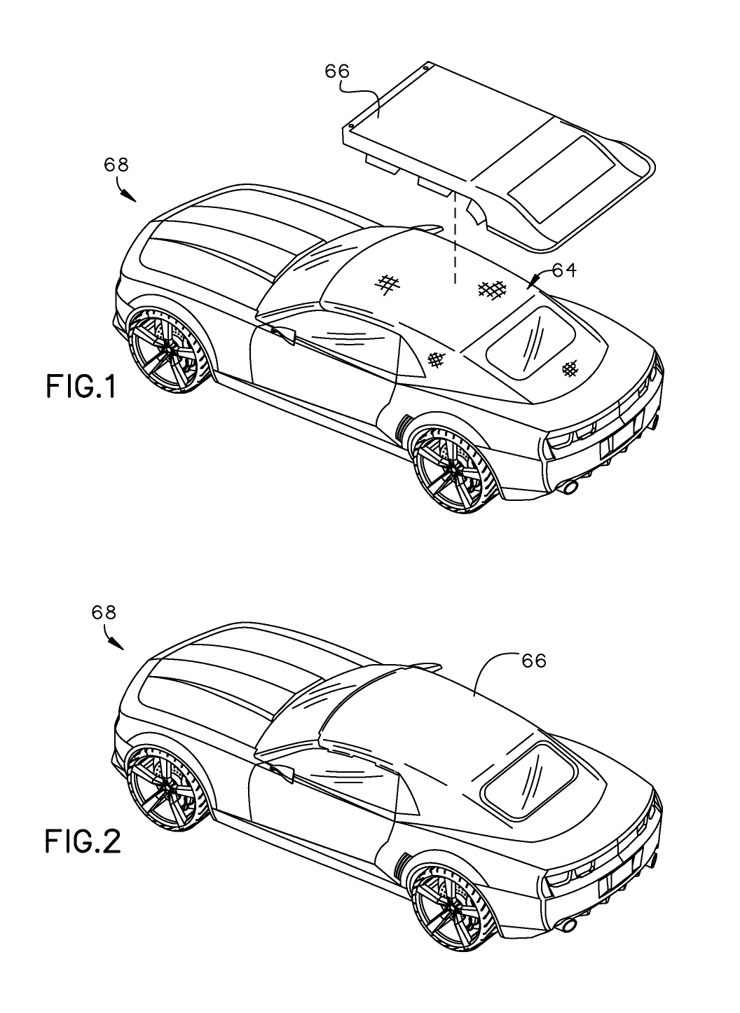

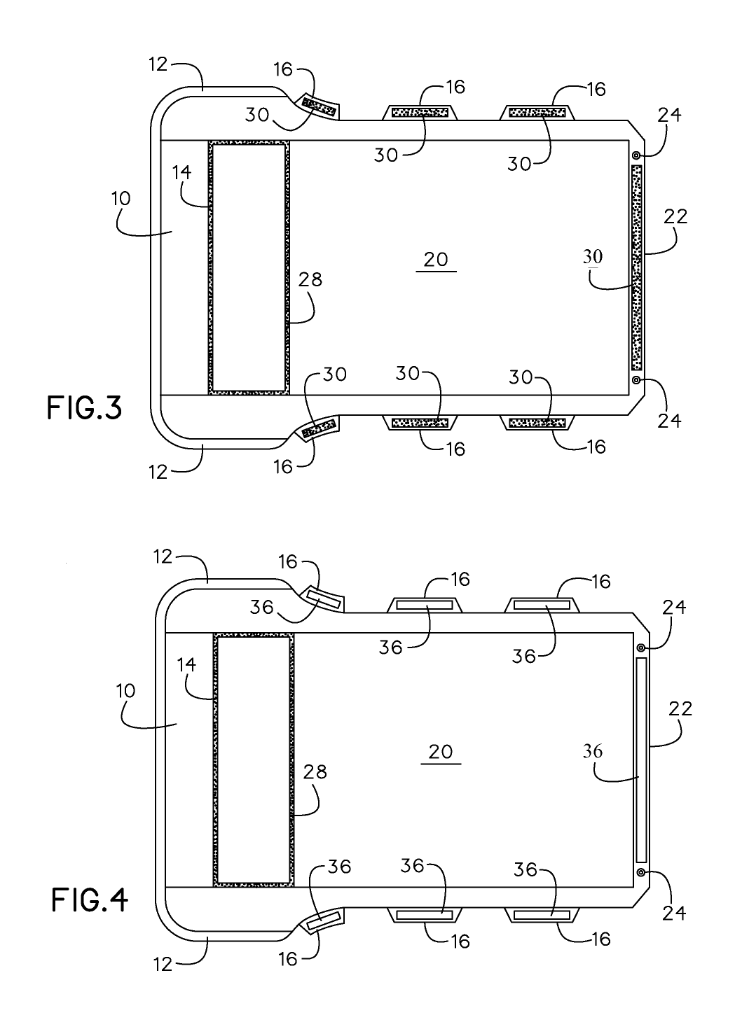

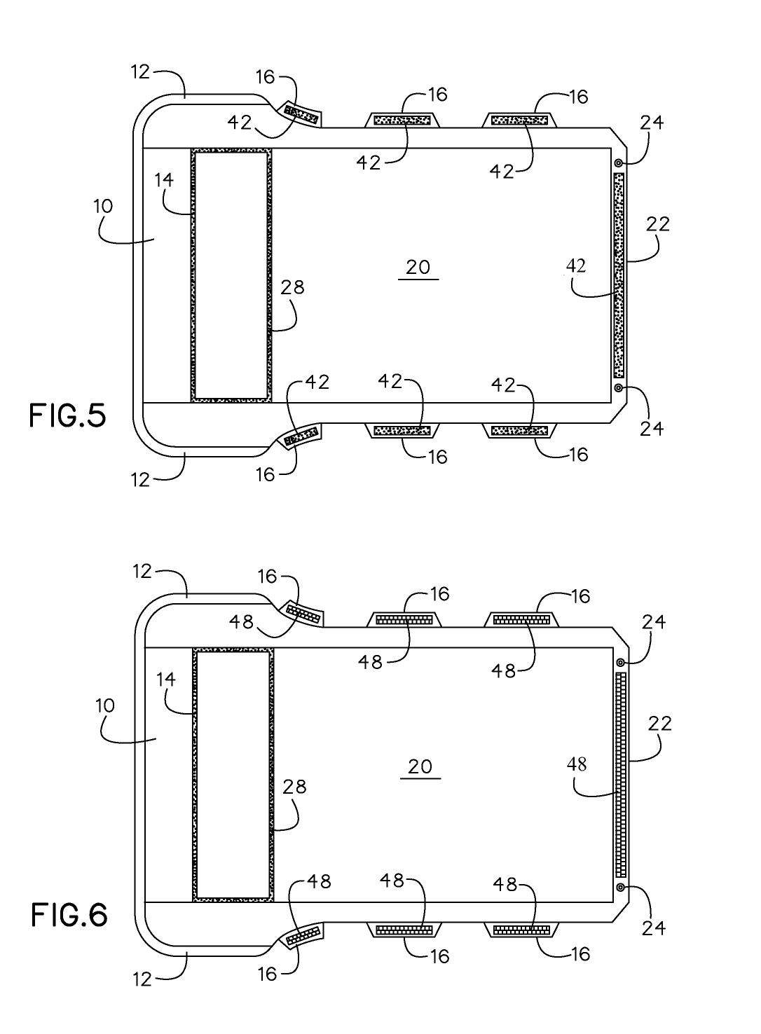

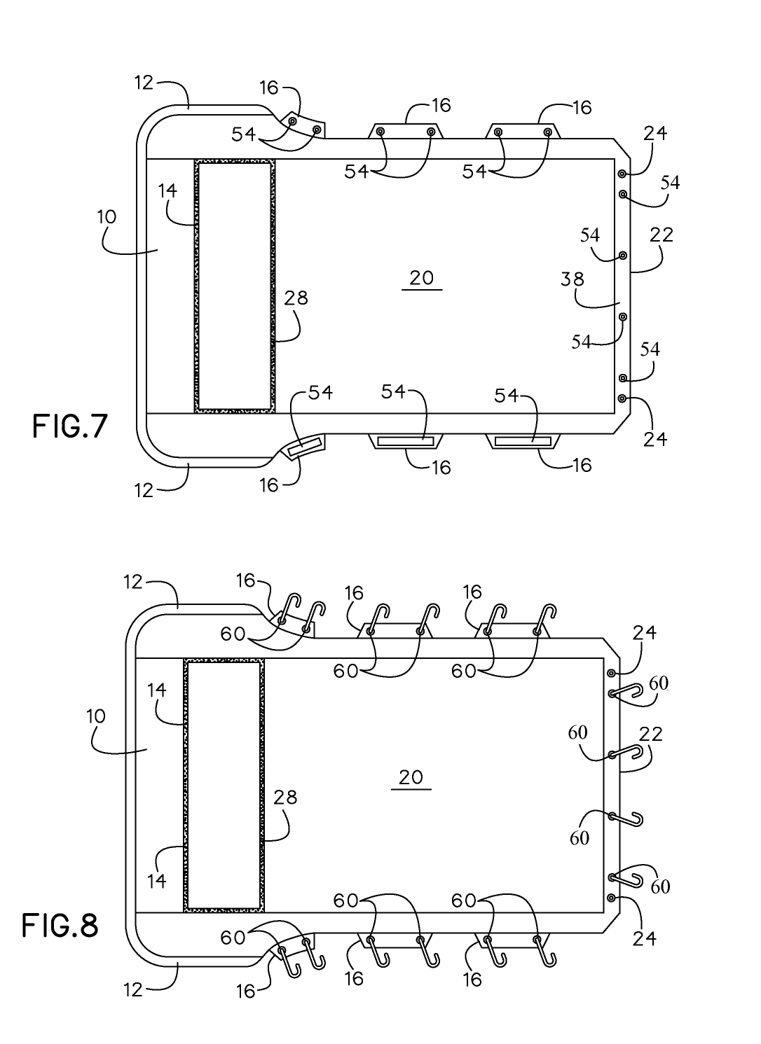

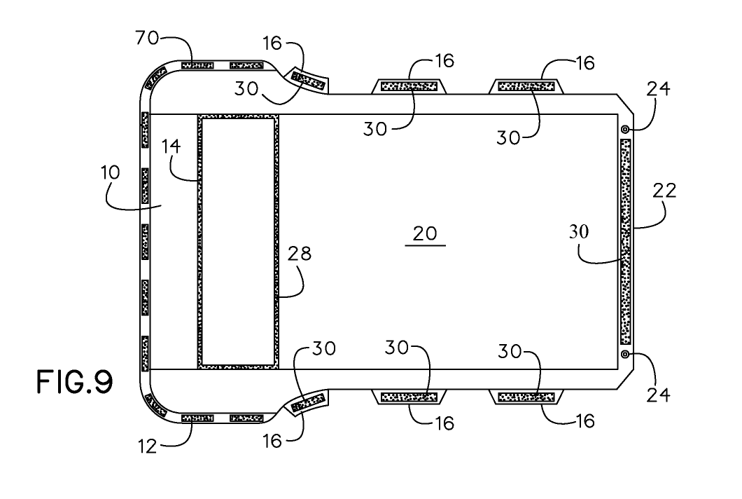

Referring to FIGS. 1 through 9, the present invention includes a top cover 66 that covers a convertible top 64 of a convertible car 68. The top cover 66 includes a body having a front portion 22, a middle portion 20, and a rear portion 10. An edge is formed around the perimeter of the body. The body is made of a flexible material shaped to cover the convertible top 64 of the car 68. The flexible material may include, but is not limited to, vinyl, canvas, leather or other textile material. A connector is used to releasably attach the edge of the body to the convertible top 64 of the car 68.

As illustrated in the Figures, the present invention may include a window cutout portion 14 through the rear portion 10 of the body. The cutout portion 14 may include a border with a second connector 28 attached. The second connector 28 may releasably attach to the convertible top 64 of the car 68 around the rear window of the car 68. In certain embodiments, the second connector 28 may be a hook and loop fastener. In such embodiments, a hook and loop fastener may be attached to the convertible top 64 that mates and secures with the hook and loop fastener of the top cover 66. However, the second connector 28 may be an adhesive or other connector. In certain embodiments, the present invention may include a plastic or glass shielding attached within the cutout portion 14.

The edge of the rear portion 10 may include a hook and loop fastener 70 or other connector. In certain embodiments, the present invention may include a tube 12 attached to the edge of the body at the rear portion 10. The tube 12 may take the place of the connector at the rear portion 10 of the body. The tube 12 may be attached to the surface of the body or may be sewn and embedded within the edge of the body. Further, the tube 12 may wrap around the corners of the body at the rear portion 10. When the top cover 10 is attached to the convertible top 64 the tube 12 may be secured within a gap in between the convertible top 64 and the body of the car 68, thereby securing the back portion of the top cover 10 to the car 68.

In certain embodiments, the present invention may include a plurality of flaps 16. The flaps 16 may protrude from the edge of the body at the middle portion. As illustrated in the Figures, the flaps 16 may include the connectors. Further, the flaps 16 may wrap around an edge of the convertible top 64 and releasably secure to the convertible top 64. In certain embodiments, each side of the body may include three flaps 16 each having a connector.

In certain embodiments, the edge near the front portion of the body may also include a connector. Further, the edge near the front portion may also include grommets 24 such as two grommets 24. The grommets 24 may be used to further connect the body to the convertible top 64. However, the grommets 24 may be used for aesthetic purposes.

The connector of the present invention may include any connector that may releasably attach the body to the convertible top 64. For example, the connector may include an adhesive 42, such as double sided tape. In certain embodiments, the connector may include a first mating connector and a second mating connector. The first mating connector may be affixed to the edge of the body, and the second mating connector may be affixed to the car 68 or convertible top 64. The first and second mating connectors may mate and releasably secure to one another. The mating connectors may include, but are not limited to, magnets 36, zippers 48, hook and loop fasteners 30, hooks and eyelets 60, or snap buttons 54.

A method of attaching a cover to a convertible car may include the following. The convertible car top cover described above may be provided. The second mating connector may be affixed to the car, such as to the convertible top.

The window cutout portion may be aligned with a window of the convertible car top. The second connector of the window cutout portion may be attached to a border of the window of the convertible car top. The tube may be placed within the gap between the convertible top and a body of the car. The first mating connector may be attached to the second mating connector, thereby attaching the convertible top cover over the convertible top of the car.

It should be understood, of course, that the foregoing relates to exemplary embodiments of the invention and that modifications may be made without departing from the spirit and scope of the invention as set forth in the following claims.

What is claimed is:

1. A convertible car top cover comprising:
a body comprising a front portion, a rear portion, and a middle portion forming an edge around the perimeter of the body, wherein the body comprises a flexible material shaped to cover a convertible top of a car; and
a connector releasably attaching the edge of the body to the convertible top of the car.

2. The convertible car top cover of claim 1, wherein the rear portion of the body comprises a window cutout portion comprising a border.

3. The convertible car top cover of claim 2, wherein the border of the window cutout portion comprises a second connector releasably attachable to the convertible top of the car.

4. The convertible car top cover of claim 3, wherein the second connector is a hook and loop fastener.

5. The convertible car top cover of claim 1, further comprising a tube attached to the edge of the body at the rear portion, wherein the tube is sized to secure within a gap between the convertible top and a body of the car.

6. The convertible car top cover of claim 1, further comprising a plurality of flaps protruding from the edge at the middle portion, wherein the plurality of flaps comprise the connector.

7. The convertible car top of claim 1, further comprising a pair of grommets attached to the edge at the front portion.

8. The convertible car top of claim 1, wherein the connector is an adhesive.

9. The convertible car top of claim 1, wherein the connector comprises a first mating connector and a second mating connector releasably attachable to the first mating connector, wherein the first mating connector is affixed to the edge of the body, and the second mating connector is affixable to the convertible top of the car.

10. The convertible car top of claim 9, wherein the first mating connector and the second mating connector comprises magnets, zippers, hook and loop fasteners, hooks and eyelets, or snap buttons.

11. A method of attaching a cover to a convertible car comprising:
providing a convertible car top cover comprising a front portion, a rear portion, and a middle portion forming an edge around the perimeter of the body, wherein the edge comprises a first mating connector;
affixing a second mating connector to a convertible top of the car, wherein the second mating connector mates with and releasably attaches with the first mating connector; and
attaching the first mating connector with the second mating connector, thereby attaching the convertible car top cover over the convertible top of the car.

12. The method of claim 11, wherein the first mating connector and the second mating connector comprises magnets, zippers, hook and loop fasteners, hooks and eyelets, or snap buttons.

13. The method of claim 11, wherein the convertible car top cover further comprises a tube attached to the edge of the body at the rear portion.

14. The method of claim 13, further comprising the step of placing the tube within a gap between the convertible top and a body of the car.

15. The method of claim 11, wherein the rear portion of the body comprises a window cutout portion comprising a border comprising a second connector.

16. The method of claim 15, further comprising the step of aligning the window cutout portion with a window of the convertible car top and releasably attaching the second connector to a border of the window of the convertible car top.
